(19) United States
(12) Patent Application Publication
(10) Pub. No.: US 2007/0041622 A1
(43) Pub. Date: Feb. 22, 2007

(54) Person identification procedure by converting fingerprints and genetic codes into barcodes, and the device used in this procedure

(76) Inventor: Eduardo Luis Salva Calcagno, Buenos Aires (AR)

Correspondence Address: JACOBSON HOLMAN PLLC, 400 SEVENTH STREET N.W., SUITE 600, WASHINGTON, DC, 20004, US

(21) Appl. No.: 10/586,913

(22) PCT Filed: Jan. 21, 2005
(86) PCT No.: PCT/US05/01871

§ 371 Date: Oct. 23, 2006

(30) Foreign Application Priority Data
Jan. 23, 2004 (AR) P040100214

(51) Int. Cl. G06K 9/00

(52) U.S. Cl. 382/124

(57) ABSTRACT

A procedure to identify people starting with known methods of fingerprint recognition, which classifies the prints according to the Vucetich method, subclassifies them according to the previous classification, converts them into alphanumeric codes, and then converts these into barcodes. To do this, there is a grid or plotting device where the characteristics points of the fingerprint are determined. They are then coded using the system's own techniques from the selective alphanumeric information in the form of a code. Once the alphanumeric code has been obtained, the conversion systems available in the device are used for the procedure to transform it into a magnetic barcode. In addition, the procedure can also identify a person by converting his genetic code (previously extracting his DNA) into barcodes. The entire procedure is put into practice by using a device especially designed for this purpose, consisting of a medium for digitally capturing images, a laser barcode reader, a computer, a database that can be in a separate server, and a printer.

### TECHNICAL FIELD OF THE INVENTION

This invention involves a person identification procedure that, starting with known methods of fingerprint recognition, classifies fingerprints by Vucetich's method, subclassifies them according to the fundamental group to which they belong, converts them into alphanumeric codes, and then converts these into barcodes.

In addition, the procedure can also identify a person by converting his genetic code (once his DNA has been extracted) into barcodes.

The entire proposed procedure is put into practice by using a device especially designed for that purpose.

### BACKGROUND OF THE STATE OF THE TECHNIQUE

Identity is the determination of the group of signs that distinguishes one individual from all others.

For many years now, man has struggled to establish an identification system that would allow him to differentiate him from others, and through research he has discovered that a series of characteristic traits and unique data that each individual has at sight and internally aid in his/her recognition. Fingerprints and DNA are the identity markers that we carry with us on our fingers and in our cells (see FIG. 1).

Fingerprint Identification

Fingerprint identification has existed for centuries. The use of this technique as a unique, unequivocal method for identifying an individual dates back to the second century BC in China, where the identity of the sender of an important document was verified by way of his fingerprint printed in wax.

During the 17^{th} century, it was well-known that fingerprints could be used to identify a person accurately.

In the 19^{th} century, the Henry systematic classification system, based on patterns such as loops and circles, was introduced, and it is currently the system used to organize fingerprint cards.

The system was developed by the British police force during the occupation of India in 1800.

Nowadays, the traditional form of rolling fingertips in ink to capture the fingerprint on paper continues to be used.

In recent years it has been shown that the digital scanning of these prints has been the most successful biometric system. The digital fingerprint recognition system accounts for 80 percent of all biometric systems.

There are many ways of conducting the identification process. The most common method involves capturing and comparing the ‘minutiae points’. Minutiae points are those points where lines come together or end (see FIG. 1).

Minutiae points are considered to be unequivocal fingerprint characteristics. These points are referred to in this manner because the system assigns them a position using coordinates.
These points can be classified by the following characteristics:
1. Bifurcation: The point where a line separates into many other lines called branches.
2. Island: Where a line opens into two branches and then closes again.
3. Ending: Occurs when a line ends.
4. Etc.

In a typical fingerprint scan, around 80 of these minutiae points are generally extracted.

DNA Identification

Over time, progress made in the field of immunology has enabled other personal identification systems to be developed. Without a doubt, the biggest step forward has been in genetic code analysis techniques, which let fragments of the DNA molecule be extracted and “read”.

This genetic code is unique to each individual and is carried in cells. It can be extracted non-intrusively to verify a person's identity by way of an organic safety seal disclosed in U.S. Pat. No. 6,659,038 filed by this applicant, incorporated herein as reference.

This safety seal consists of a device that is capable of storing the fingerprint and DNA of the person entered into the system that is taken from his fingerprints by way of reactives and microscopic readings that can lift the organic remains of cells attached to the adhesive material of the organic safety seal.

This process enables us to obtain the genetic code of the person to be identified and link him to the fingerprint found in the database. As we will see further on, the proposed procedure lets us identify a person by coding into barcodes both of the unique and unrepeatable characteristics of every human being: fingerprints and DNA.

The Vucetich Formula

The formula is an ordered series of letters and numbers that represents the types of fingerprints for each one of a person's 10 fingers.

The formula starts being recorded by fingerprinting the thumb of the right hand and continues in the natural order of the fingers on the hand, ending with the little finger. Then the identical operation is done starting with the thumb through the small finger of the left hand.

To code the formula, you need to differentiate the thumbs from the rest of the fingers, using in each instance the coding process shown in FIG. 3.

These four large groups Juan Vucetich determined are established according to the particular arrangement of their lines. In the 20^{th} century, this allowed for there to be a noticeable decrease in searching for print identity by limiting it to just one of these key signs.

This coding lets us classify a fingerprint and transform it into an alphanumeric formula.

Biometric Identification Techniques

The digital mold of a fingerprint is one of the longest in biometric systems. It requires anywhere from a few hundred up to thousands of bytes, depending on the level of security. States and governments have an A.F.I.S. type Fingerprint Identification System.

This biometric technology is used in fingerprint recognition that uses proprietary algorithms, creating a database as an intelligent tool whose objective is to identity an individual by using any of his 10 fingerprints and comparing it to the fingerprints found in the database after a very brief search.

Barcode Technology

The first barcode system was patented on Oct. 20, 1949 by Norman Woodland and Bernard Silver. It dealt with a series of concentric circles. The products were read by a photodetector.

In the 1960's, the first fixed barcode scanner installed by Sylvania General Telephone appeared. This device read red, blue, white and black barcodes identifying railroad cars.

By 1969, laser came on the scene. Using light from Helium-Neon gas, the first fixed scanner was installed.

In 1971, Codabar appeared and was mostly used by blood banks, where an automatic verification and identification system was essential.

[image]

One year later, in 1972, ITF, created by D. David Allais, came on the scene.

[image]

By 1973, the U.P.C. code (Universal Product Code) was announced, and it became the standard product identification system. Updating inventories automatically allowed for goods to be restocked better and faster. Europe came onto the market in 1976 with its own version—the EAN code (European Article Number).

[image]

In 1974, Dr. Allais once more, in conjunction with Ray Stevens from Intermec, invented Code 39, the first alphanumeric type code.

[image]

Later, the first patented laser barcode verification system, the PostNet system, a postal service used in the USA

[image]

and scanner-applied CCD (Charge Coupled Device) technology came onto the market. This kind of technology is currently widely used in the Asian market, while laser is used more in the Western world. In 1981, the alphanumeric Code 128 appeared.

[image]

Recently in 1987, Dr. Allais developed the first two-dimensional code, Code 49. Ted Williams (Laser Light Systems) followed with Code 16K in 1988.

The 1990's began with the publication of ANS X3.182 that regulates the quality of a lineal barcode impression. That same year, Symbol Technologies came out with the two-dimensional code PDF417.

[image]

Today more different kinds of codes used in different environments are emerging every day.

Identifying a Person through a Barcode

A barcode, as described in the above historical summary, is a series of black bars and white spaces of different widths that are printed. In the proposed procedure, the barcodes would condense the information from a fingerprint and/or a genetic code. In this way, the barcode represents these forms to identify people archived in an A.F.I.S. database or a similar fingerprint or genetic print database.

The barcodes are read with a scanner, which measures the reflected light and interprets the code in numbers and letters that are sent to a computer. The information stored in the database is checked by the system, and the fingerprint is displayed on your monitor for subsequent verification.

Digital Image Processing Techniques

Images, originally in a physical medium, are acquired by a vision sensor (a photo or video camera or optical scanner) and are stored in a computer on acquisition and digitalization hardware. Once the image has been digitalized, algorithms are executed and coded in a programming language and then processed. These algorithms are called techniques and are grouped depending on their specific objectives. This is called digital image processing, and it encompasses mathematical, computer, electronic and physical concepts, developments and theories.

### BRIEF DESCRIPTION OF THE FIGURES

FIGS. 1A, 1B and 1C show the flow chart of the first phase of the procedure, consisting of inputting a person's data into the database;

FIGS. 2A and 2B show the second phase involving verifying the person's identity;

FIG. 3A shows the phase involving identifying a person by his fingerprint;

FIG. 3B shows a detail of identifying a person by his DNA;

FIG. 4 shows a flow chart of the system's algorithm that converts a fingerprint into a barcode;

FIG. 5 shows the flow chart of the system's algorithm that converts a genetic code into a barcode;

FIG. 6 shows the image of a digitalized fingerprint;

FIG. 7 shows the image of FIG. 6 in a grid-like chart;

FIG. 8 shows the four fundamental groups of fingerprints;

FIG. 9 shows fingerprint subclassifications;

FIG. 10 shows the core loop and delta subclassification elements;

FIG. 11 shows various fingerprint subclassifications;

FIGS. 12A and 12B show further subclassifications;

FIG. 13 shows minutiae patterns;

FIG. 14 shows an example of fingerprint identification;

Images 1 and 2 show fingerprint cards;

Image 3 shows individual segmentation;

Image 4 shows an example of a fingerprint with adequate quality;

Image 5 shows a fingerprint with a marked core;

Image 6 shows a gray scale and a binarized fingerprint;

Image 7 shows an orientation graph;

Image 8 shows a graph to a print; and

Image 9 shows a fingerprint with a grid.

### GENERAL DESCRIPTION OF THE INVENTION

The proposed identification procedure is put into practice by using a device that includes a computerized identification system capable of classifying information, transforming into alphanumeric codes, and then into barcodes.

This device consists of a series of apparatuses or devices that when they are used according to the proposed procedure let you obtain the desired result.

The device consists of a flatbed scanner, a fingerprint sensor, a digital camera or any other similar digital medium that can reproduce the digital image of a fingerprint. This scanner or other digital medium is connected to a computer that has software that is capable of converting fingerprints and genetic codes into barcodes, a process that will be described further on. In addition, this computer has a type of laser barcode reader currently available on the market.

This same computer is connected to a general database where the records containing the State or country's information about the person is going to be kept. This database has a database engine or administrator that can be in the same computer or in a separate server, depending on the volume of information to be stored.

Finally, the device has a laser or thermal printer capable of printing the resulting barcodes onto both self-adhesive labels and sheets of paper that have the quality necessary to be read without difficulty by the aforementioned laser reader.

The proposed invention constitutes a safety tool to be used by States, countries, governments, and other institutions, primarily for access control, although it can be extensively used in other kinds of fields, for example, financial and police institutions.

This safety tool has a person's identification information condensed into a barcode. This information is complete and includes the fingerprint of the person you want to identify and his anthropometric distinguishing features and other civil and criminal data that a person may accumulate throughout his life.

This process is achieved by combining the technologies described above plus applying a unique formula to classify and subclassify prints and then transform them into an alphanumeric chain.

The fingerprint is then transformed into a barcode that can be used to identify a person, and the user can directly view this information on a computer screen that is part of the device used in the proposed procedure.

The aforementioned barcode consists of a series of black bars and white spaces of different widths, resulting from a biometric, numeric and alphabetic combination that stores the previously selected and analyzed fingerprint information on a grid especially designed for that purpose.

The code is read by an optic laser reader that will automatically bring up the image of the fingerprint of the person you want to identify and compare the fingerprint to the dactyloscopic or fingerprint card previously stored in the system.

To verify a person's identity, the person will place a finger onto a scanner or other similar digital medium. Then the system will generate the chain of characters associated with that print and compare it to the one belonging to the person found in the previously loaded database. If the character chains are from the same print, the identity verification result will be positive.

This procedure that is based on the particular device described above presents two main features in its use: the speed and safety in transmitting the information.

A code containing a fingerprint in an information of X characters can be read, decoded and entered into a computer in under one second, over seven times less than if it were to be done manually. In addition, the accurate transmission guarantees the safety of the data 100%.

Another obvious advantage versus known systems is that when a fingerprint is entered into them to be identified you have to search all databases in a common point search, while the proposed procedure preclassifies the prints and then converts them into alphanumeric codes first and then barcodes. This means that the search will be noticeably faster, since the system only has to look in a subgroup of common prints fitting a determined parameter, making it unnecessary to search in the other groups that have different characteristics.

This is a distinct advantage when you compare the problems this invention solves compared to the history of the state of the technique.

As stated above, the resulting barcodes link information from both a fingerprint and a genetic code.

To create a barcode of a fingerprint, a process is started that generates a numeric code generally linked to another alphabetic code and combined with another print biometric reader. That way a system that is tremendously easy to implement for any kind of personal identification document is generated, which—regardless of their size or function—will be printed in the form of a barcode instead of an actual fingerprint (Identity Cards, Social Security Number, Passports, Driver's Licenses, social welfare program cards, credit cards and other civilian, military, and diplomatic credentials, etc.).

It should be mentioned that this system can be vastly applied in different areas.

Therefore, it would be true to say that the proposed procedure can be used anywhere information needs to be captured, previously codified in a database. Combined with data collection technology, barcodes provide a fast, accurate and efficient way to collect, process, transmit, register and protect information on identity cards as a safety barcode that condenses fingerprint information and a genetic code, among other things.

Currently, digital fingerprint technology is based on two methods: optic and capacitive.

The optic method requires the user to place his finger on a piece of glass onto which a device projects a light. The image is then captured by charge coupled device (CCD).

The optical methods have been widely used and have been in existence since the last decade. They have been tested, but have not always been reliable due to environmental conditions.

A layer of dirt, grease or oil on the finger can leave a ‘ghost’ that's called a ‘latent image’. As a result, this system has been confined for use by the criminal justice system and by military installations.

On the other hand, the capacitive method would appear to be geared toward the masses, making the capturing devices more compact, less expensive and more reliable. Capacitive systems analyze a print by detecting electrical fields around the finger using a chip sensor and a group of circuits.

### DETAILED DESCRIPTION OF THE INVENTION

Below is a step-by-step description of all of the operating phases in order that are needed to attain the result you are looking for: converting a fingerprint and/or genetic code into a barcode. Afterwards, a particularly detailed description will be given of the conversion stage, explaining the software processes making up the aforementioned device.

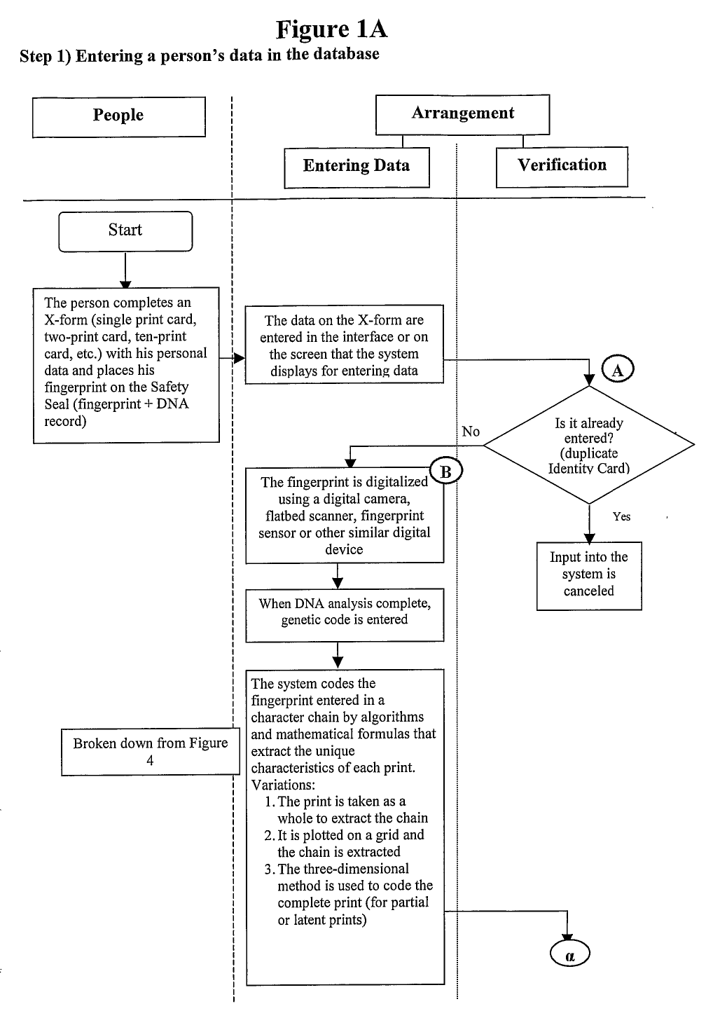

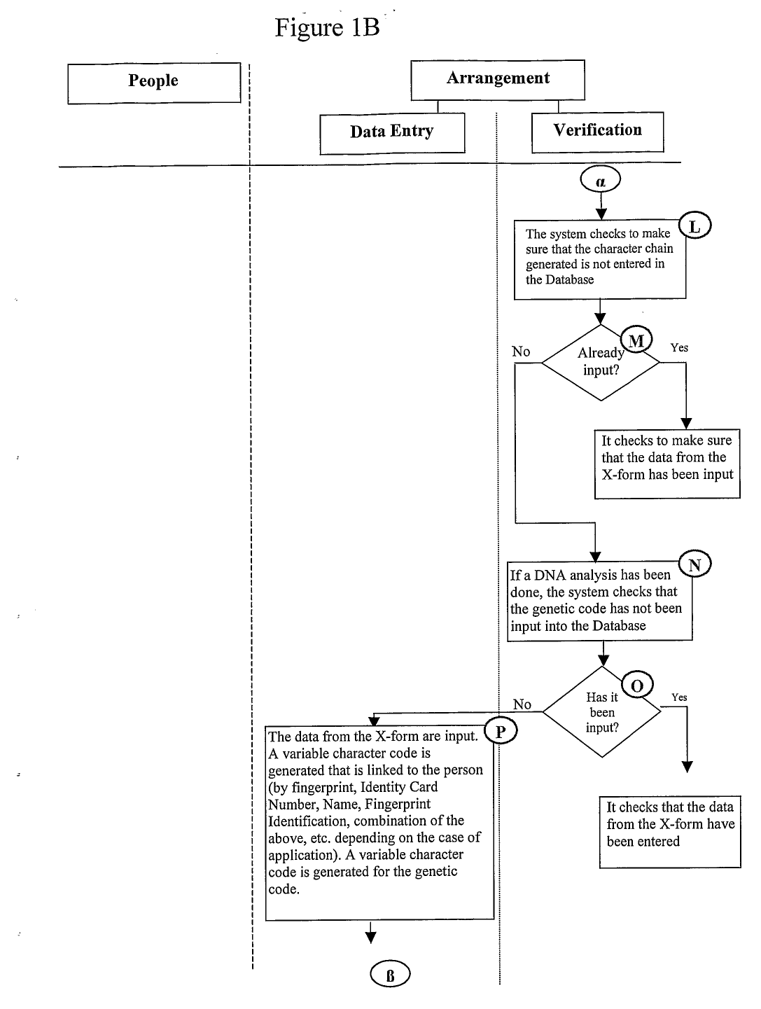

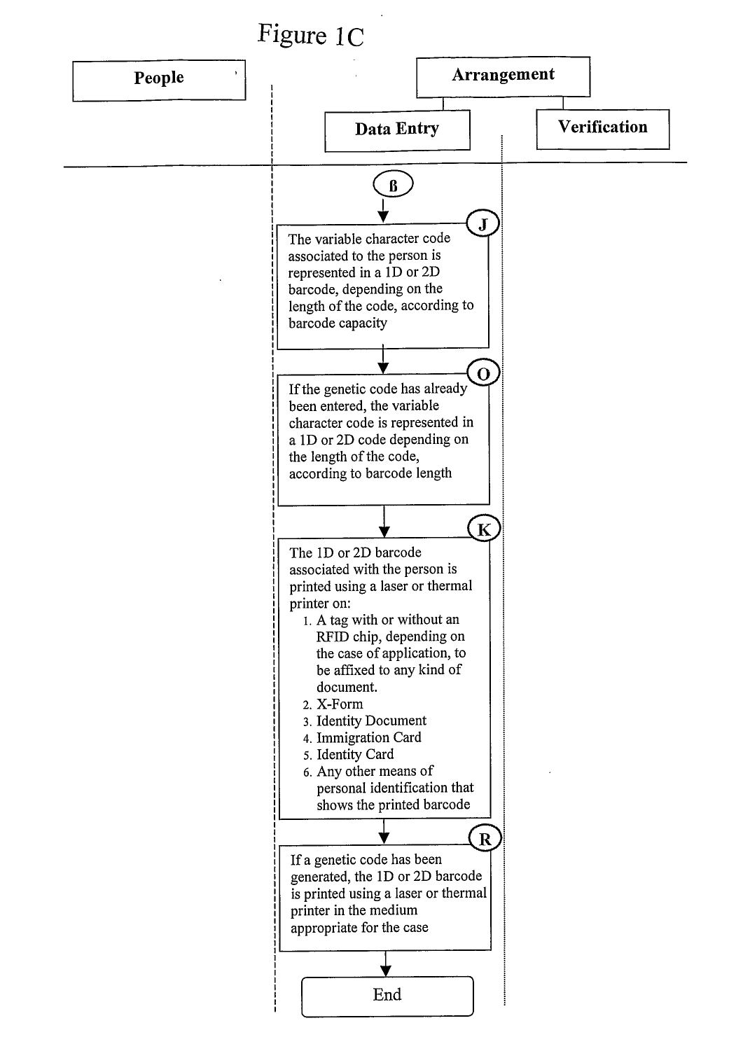

Phase 1 (FIG. 1A): Inputting a person's data into the software database.

Adding the data of the person you want to identify to the general database is preferably done using an X-form that has been especially adapted for this process which incorporates the teachings found in U.S. Pat. No. 6,659,038 this applicant filed; otherwise it could be done using the forms commonly known for these requirements. This X-form has a safety seal to capture a certain number of prints and is a supporting device capable of storing the fingerprint and the DNA of the person input into the system whose fingerprints have been extracted using reactives and microscopic readings that can lift organic remains of cells attached to the adhesive material of the organic safety seal or by other intrusive methods like the ones currently used (blood or hair samples or skin analysis, etc.)

Through this non-intrusive process, you can obtain the genetic code of the person you want to identify and link it to the fingerprint obtained in a database.

For a person who has already been identified by prior conventional means, for example ink-based fingerprint cards, this data can also be input into the database, even if their quality is less than those captured by using the safety seal.

In this fashion, the entire spectrum of the population is included: those who have already been identified by traditional forms, and new ones who are going to be added through the new identifications obtained with the safety seal contained on the X-form.

In this phase 1 of inputting data, the first operations are manual. Then, starting with step (A) which is described further on, manual operations are combined with automatic ones. The operator inputs a person's data as they are found on the X-form into data input software interface.

Step (A): The operator enters the person's identity credential number, and the system performs a query on the table that registers people in the database, whose condition for being selected is that the field for the identity credential number has to be the same as the number input by the operator (it can also be done by name, fingerprint identification, etc.)

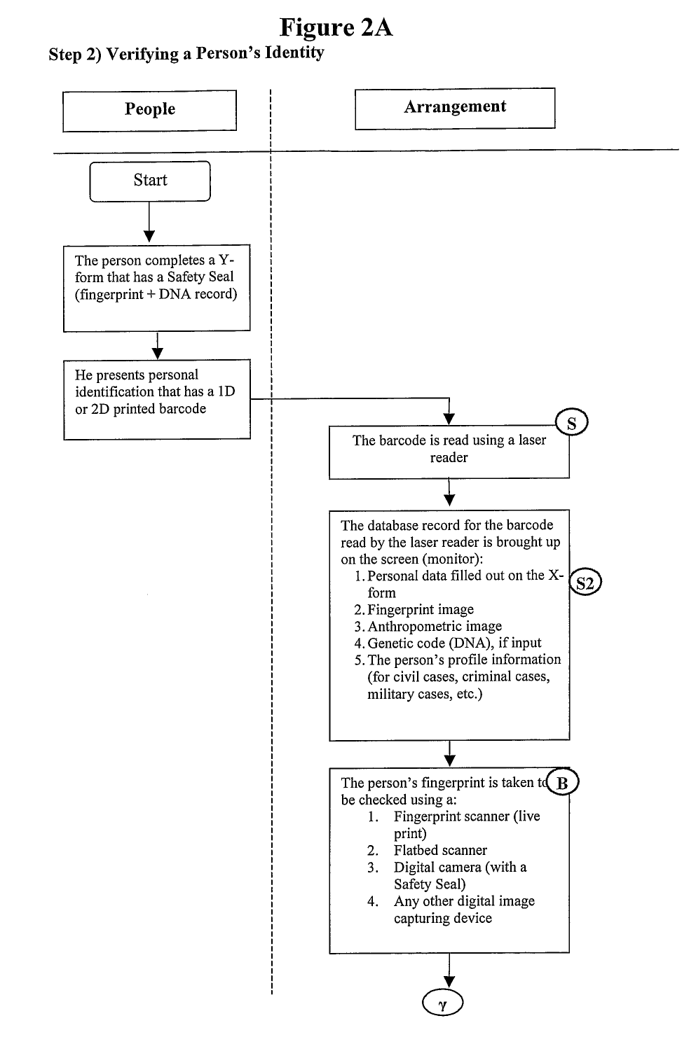

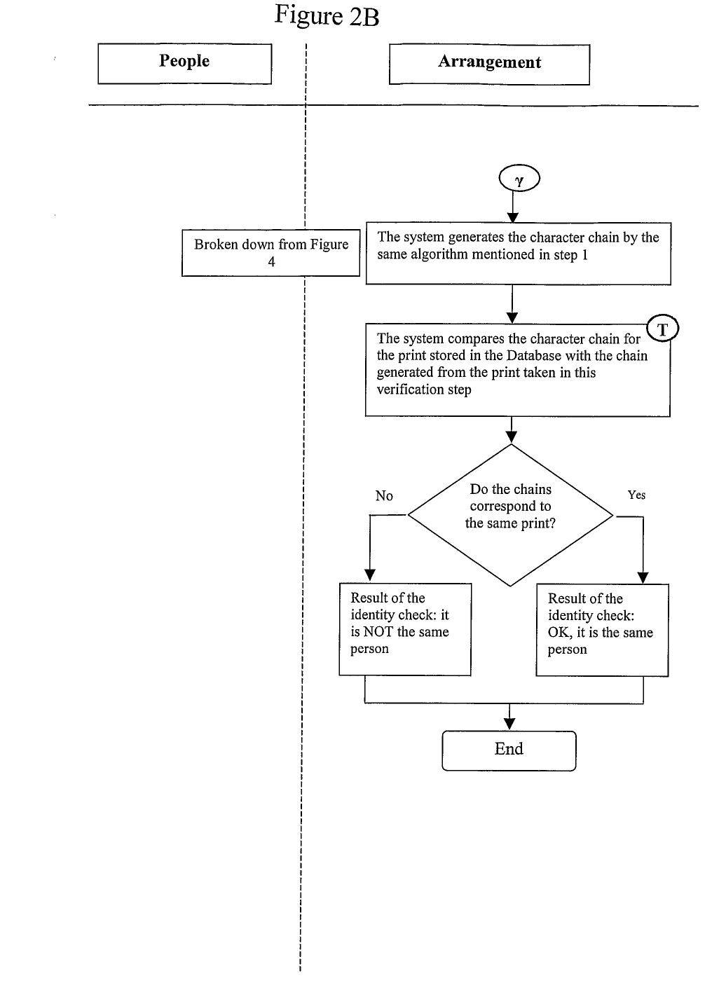

If the query returns a record, it means that the person with that identity credential number you are trying to enter IS registered. If this happens, inputting into the database is canceled and you go directly to Step 2 (Step S2, FIG. 2A).

If the query does not return any record, it means that the person with the identity credential number you are entering is NOT registered in the system, and you continue with the normal input procedure.

Step (B): Depending on the digitalization device you are using, there may be two alternatives to capture a fingerprint. In the first one, the fingerprint image digitalization process has to be initiated by a software order (i.e., low production flatbed scanner).

The software takes the previously set parameters to perform the digitalization, such as:
Horizontal and vertical resolution: 500 dpi
Bit depth: 8
Color: 256 gray
Digitalization area(s): variable

The software checks that the device is connected and working properly; then it orders the connected device to start digitalizing the fingerprint image or images found on the X-Form with the pre-set parameters.

Next, the software receives the digitalized fingerprint images into its memory. In the second alternative for capturing a fingerprint, the digitalization device captures the image(s) of the fingerprint and then transfers it to the software (i.e., fingerprint sensor, digital camera).

The digitalization device capturing the image of the fingerprint must at least meet the following specifications:
Horizontal and vertical resolution: 500 dpi
Bit depth: 8
Color: 256 gray

Next, the device makes the transfer and the software receives the digitalized fingerprint image(s) into memory.

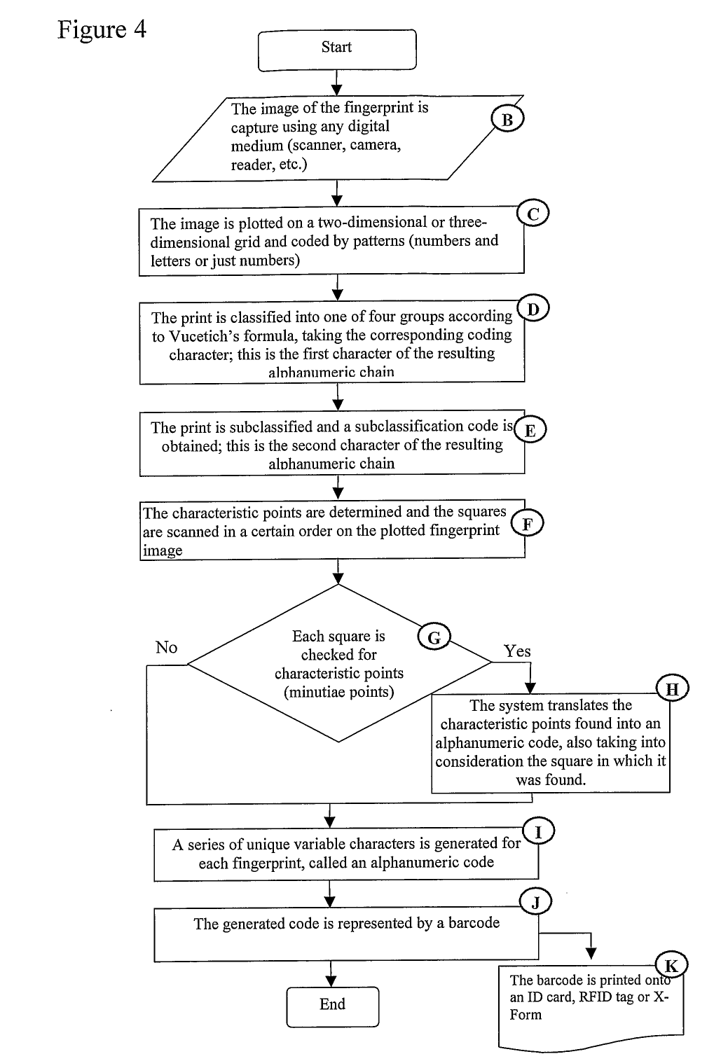

Finally, the software processes the image(s) according to step (C) FIG. 4, regardless of which capturing alternative was selected.

Next, if DNA analysis were done, the genetic code is input into the database; otherwise the space is left blank.

Then the software codes the fingerprint that was entered into a chain of characters by algorithms and mathematical formulas that extract the unique characteristics of each print. This allows the user to choose from the following variants:
1. Take the print as a whole for the extraction of the character chain.
2. Plot on a grid and extract the character chain.
3. Use the three-dimensional method known in the state of the technique to code and reconstruct the full print, if only a partial print were obtained, for example, for traces or latent prints.

The entire fingerprint coding process performed in this Phase will be described further on when FIG. 4 is described.

Then, continuing with Phase 1, a step (L, M) is carried out that distinguishes this procedure from all known systems: the system checks to make sure that the character chain that has been generated has not been input into the database, and it also checks to make sure that the data found on the form that has the safety seal is being input; otherwise, the system will not let it be input.

In practice, this means that it will be impossible to “steal” or replace another person's identity, like getting a fraudulent document, for example, because the system will automatically detect whether the print you are attempting to enter for a certain person is already input and belongs to another person, and inputting will be canceled and the system will not let it be input. This does not happen in current identification systems, which let you enter the same print under different names twice, so these systems are unable to combat the falsification of documents per se.

This is another considerable advantage this invention poses versus previous devices in history.

In this stage or step (L, M), the software takes the first two characters of the alphanumeric chain that was obtained and performs a database query whose condition of selection is that the first two digits of the codes registered in the database have to match the classification code (first character) and the subclassification code (second character). In this way, you get an extremely reduced subgroup of character chains of candidate fingerprints.

Then, the software compares the minutiae points between the alphanumeric characters obtained and each of the candidate character chains in the subgroup that were returned from the database query, and it compares the following characteristics:
Grid on which it is found
Type of minutiae
Quality
Orientation or Direction

If at least five minutiae points match between the character chains in type, location, situation and direction, it is the same print and it is then loaded into the database.

In this case, if the print had already been input, the software would display the information involving the print in question on the screen, and the operator can compare this information with the information found on the X-form for the person he wants to identify.

If the print had not been previously input, then the system checks to make sure that there are no duplicate genetic codes, which is done next (N) if a genetic code has already been done by DNA analysis.

The operator inputs into the software the chain corresponding to the genetic code obtained and then performs a query on the table that registers people in the database, and the condition of this table is that the field pertaining to genetic code has to be the same as the one the operator entered.

In stage or step (O) of this phase 1, if the database query returns a record, it means that the person with the genetic code you are trying to enter IS registered, and the operator is then able to compare this information with the information found on the X-form of the person he is trying to identify.

In turn, if the database query does not return any record, it means that the person with the genetic code the operator is trying to enter is NOT registered, so once the system verifies that both codes have not been previously entered (M, O), the operator should continue with the normal input procedure (P).

In this step (P), the software records a person's data in the database depending on the information input according to the X-Form and stores the character chain generated from the fingerprint.

If the operator had already entered the genetic code obtained through DNA analysis, the software records the character chain pertaining to this genetic code. Then, in step (J), a barcode character coding program is used to represent the character chain(s) obtained. It can represent either the fingerprint or also any other information that allows a person to be individualized, depending on how it is applied. For example:
Identity Credential Number
Name
Fingerprint Identification
Any combination of the above

Depending on the number of characters to be represented, a one-dimensional barcode or a two-dimensional code will be used.

Then, in stage or step (Q), a barcode character coding program is used to represent the character chain for the genetic code. Just like in the preceding step, depending on the number of characters to be represented, a one-dimensional barcode or a two-dimensional code will be used.

In the next step (K), the software sends the barcode information to be printed by a thermal or laser printer or a printer of similar technology that gives the printed barcode enough quality needed to be read by the laser reader.

The physical medium on which the barcode can be printed can be any of the following: self-adhesive label or sticker that can be removed and affixed to any document, or the aforementioned X-form, Identity document, Passport, or any other personal identification medium that shows the printed barcode.

After phase 1 has been completed, in step (R) the software sends the barcode information representing the genetic code to a thermal or laser printer or to a printer of similar technology that has enough quality for the barcode to be read by the laser reader.

Phase 2 (FIGS. 2A and 2B): Verifying a person's identity.

Assuming that this invention were used officially in a specific country or region and that all its inhabitants had identification documents with barcodes, as described in phase 1, the process to verify a person's identity would be done as follows:

The person would present to the pertinent authority his bar-coded identity document, which would be read by a laser reader (S). Another option would be for the citizen to fill out a form (Y) with a safety seal and give a fingerprint and subsequent DNA sample, if the authority on duty so requires, to leave a physical record of the verification that is going to be done.

This laser reader, which is connected to a PC containing the software, reads the barcode printed on the person's personal identification document and transfers the information it has read, which is taken by the software from the communication port to which the laser reader is connected.

Then, the software performs a query on the table that registers people in the database, and its condition is that the barcode field (depending on the case, this barcode can represent a fingerprint, genetic code, identity credential, fingerprint identification, etc.) has to be the same as the one being read by the laser reader.

Then, in step (S2), the software will display on the monitor all of the information previously registered that is linked to the barcode that has been read regarding the record obtained from the database query. Some of these can be: photographs, personal data filled out on an X-form, fingerprint image, anthropometric images, genetic code (DNA) if entered, a person's profile information (for civilians, criminal cases, military cases, etc.)

Then, in stage or step (B), the fingerprint is digitalized using a fingerprint sensor, flatbed scanner, digital camera, or any other digital device that captures an image. This step (B) was already described in Phase 1.

The software will generate a character chain using the fingerprint coding process that is going to be described further on when FIG. 4 is described.

The next step in this phase 2 is step (T), where the software will compare the character chain that was obtained from the print entered into the system to the chain that was previously stored as belonging to that print.

The software takes the first two characters of the barcode that was read by the laser scanner, the first character pertaining to the classification code and the second character to the subclassification code. The software compares the first character of the barcode that was read to the first character of the chain recovered from the database. If they match, the comparison continues; as long as there is no match, it is concluded that both chains do not correspond to the same print.

If the first character matches, the second character of the barcode read is compared against the second character of the chain the database recovered. If they match, the comparison continues; as long as there is no match, it is concluded that both chains do not correspond to the same print.

In turn, if the second character matches, the software compares the minutiae points between both character chains by comparing the following characteristics:
Grid they are placed on
Type of minutiae
Quality
Orientation or Direction

If there is a match of at least five minutiae points between both character chains, in the same type, location, situation and direction, it means that the print is the same and so it is the same person as the one originally input, and so the result of the identity verification is positive.

If there is no match of at least five minutiae points, it is concluded that the chains that were compared do not have to do with the same print, and so the result of the identity verification is negative.

If a different person wants to replace his personality by way of a falsified document, it would be immediately detected because when his print is checked it could never match one that is already registered in the database a print corresponding to another person.

In the event the result of the identity check is positive and you proceed to Phase 1 (inputting a person's data), a final stage or step (V) is performed where you corroborate that the data and fingerprint registered for the person correspond to the fingerprint captured live, which means that the information registered in the database is correct.

Otherwise, if the result of the identity check is negative and you proceed to Phase 1 (input a person's data), the last step of the phase would be step (W), where the pertinent actions are taken to check why the data and the fingerprint registered to the person do not match the fingerprint captured live.

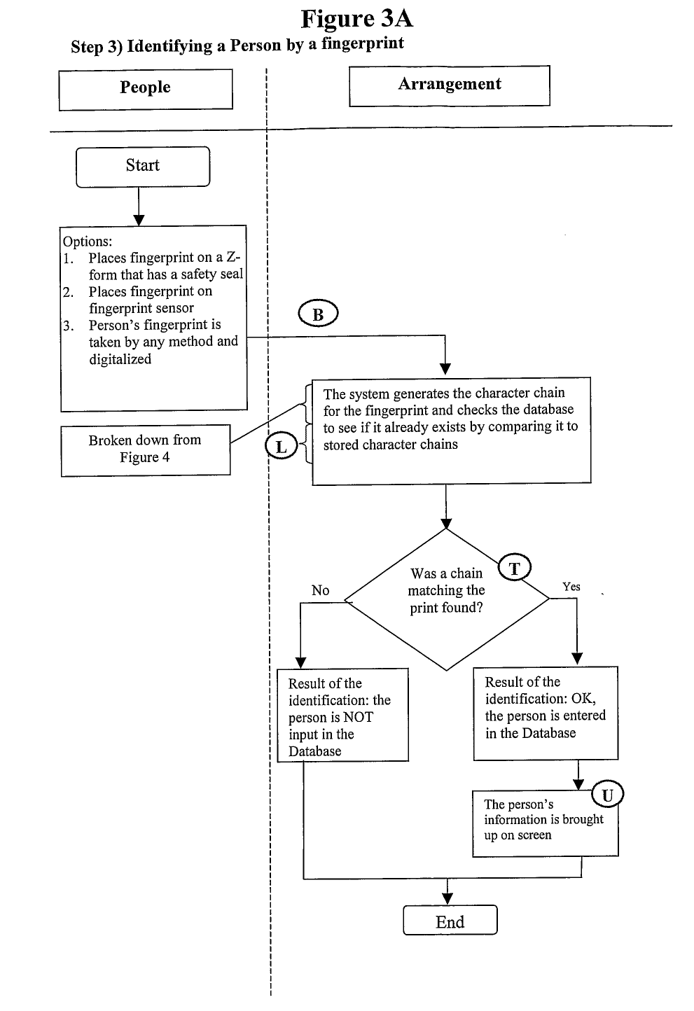

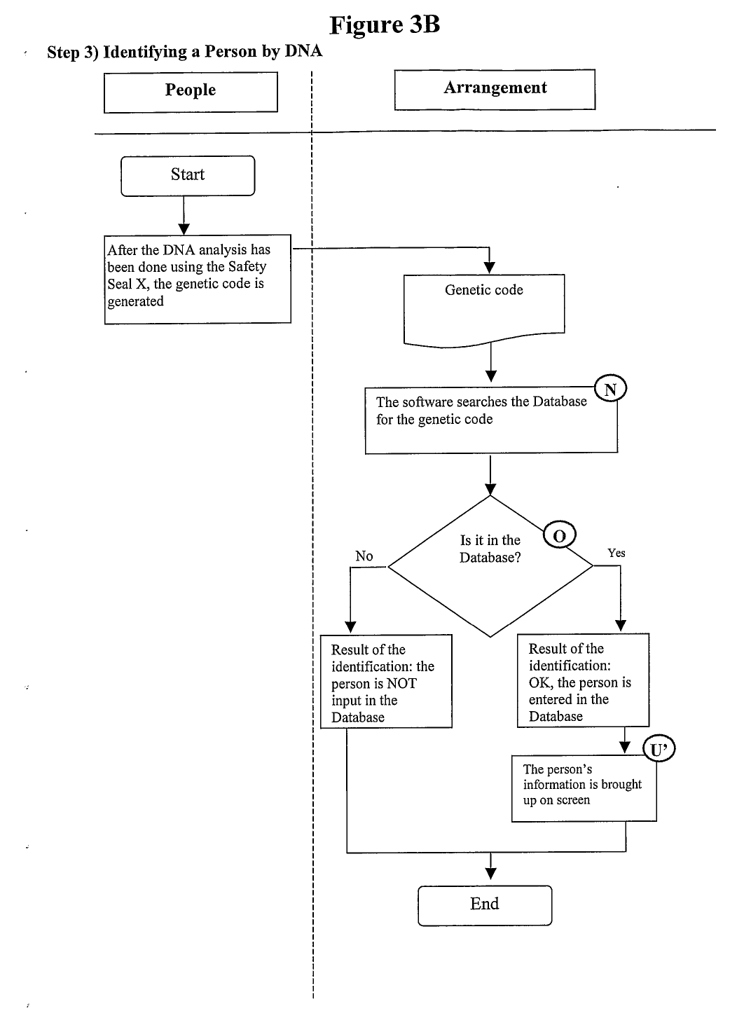

Phase 3a (FIG. 3A): Identifying a person by fingerprint.

In the event a person who you want to check does not have his identity documents with him at the time he is checked, the printed barcode cannot be used. However, you can identify the person in question by taking his fingerprint and/or DNA. This would be the process to follow:

The person to be identified would place his fingerprint on one of the capturing devices cited above: the form (Z) with a safety seal (similar to the X- and Y-form) that captures the DNA with chemical reactives, a fingerprint sensor or other digital device. Then the print entered is digitalized using step (B) of phase 1.

Using the digitalized print, the software will generate a character chain by way of a fingerprint coding process that will be described later on when FIG. 4 is described.

Following the steps in FIG. 3A, note should be made that the software performs the same stage or step (L) described above in Phase 1, where the software takes the first two characters of the alphanumeric chain obtained and performs a database query or consultation, whose condition of being selected is that the first two digits of the codes registered in the database have to match the classification code (first character) and the subclassification code (second character). This gives you an extremely reduced subgroup of character chains of candidate fingerprints.

Then, the software compares minutiae points between the alphanumeric character chains that were obtained and each of the character chains of the subgroup the database query returned by comparing the following characteristics:
Grid where it is found
Type of minutiae
Quality
Orientation or Direction

If at least five minutiae points match (T) between the character chains, in the same type, location, situation and direction, it is concluded that the print to be identified has already been entered in the database and the result of the identification is positive.

In this case, since the print has already been entered, the software displays on the screen (U) the information involving the print in question and, consequently, involving the identified person.

If there is not a match of at least five minutiae points between the character chains, in the same type, location, situation and direction, it is concluded that the print to be identified is not registered in the database, and the result of the identification is negative, which means that the person to be identified is not entered in the database and, consequently, is undocumented.

Phase 3b FIG. 3B): Identifying a person through DNA

A variation of phase 3a above is the following one, which consists of identifying a person through his DNA obtained by the non-intrusive safety seal or by any known intrusive method:

The person you what to check enters his fingerprint on the X-form with the safety seal, which, as indicated above, consists of a device capable of storing the fingerprint and the DNA of the person entered into the system, extracted from his fingerprints using reactives and microscopic readings that can lift organic remains of cells attached to the adhesive material of the organic safety seal.

Once the corresponding DNA analysis has been done on the print entered on the X-form with the safety seal or the organic sample taken using other methods, the operator inputs the genetic code obtained into the software, which, as we will see below, is an alphabetic character chain.

Then, the software performs a query on the table that registers people in the database, and a condition of this table is that the field for genetic code has to be the same as the code entered by the operator (N).

It should be mentioned that in this step of phase 3b, the software performs the same actions as the ones cited for stage or step (O) of phase 1, which means that if the database query returns a record, this means that the person with the genetic code you are attempting to identify IS registered. In this case, the software displays the information linked to the genetic code in question and, consequently, about the person identified on the screen (U′).

On the other hand, if the database query does not return any record, it means that the person with the genetic code you are trying to identify is NOT registered, and so it is concluded that the identification process is negative.

This phase of identifying a person by his DNA is complementary to the phase above (by fingerprint) and is to be used in very different situations, depending on the requirements.

While phase 3a is to be used to identify people immediately in places like airports, land borders, police departments, etc., phase 3b would be of great assistance in cases such as airplane accidents, fires or natural disasters where the identity of victims has to be recognized from traces of genetic information collected. In these situations, the corresponding DNA analysis will be done on the remains found and then the genetic code that is obtained will be entered into the system. The software will perform a search as described above for the genetic code obtained in the database. If it were registered previously, the identity of the deceased will be known.

Up to now, we have given a general description of the steps of the proposed procedure, describing how each of the phases needed to use the process work, depending on specific needs: inputting a person's data, checking his identity with or without documents, etc.

Next, we will describe in detail how to put the invention into practice using the most characteristic point that differentiates it from all other systems previously known: by converting fingerprints and genetic codes into barcodes.

To do this, we copy the fingerprint shown in FIG. 1 and plot it on a grid of predetermined segments and measurements, which are identified by letters and numbers; that is to say, an alphanumeric grid. This grid or chart is a novelty and is part of the invention, because it backs up all subsequent actions of the system.

Through this process, the software first obtains the classification of the type of fingerprint according to the Vucetich classification, and it falls into one of the four fundamental groups in existence. The print is then subclassified according to fundamental group, and then the minutiae patterns or characteristic points found in the image are extracted.

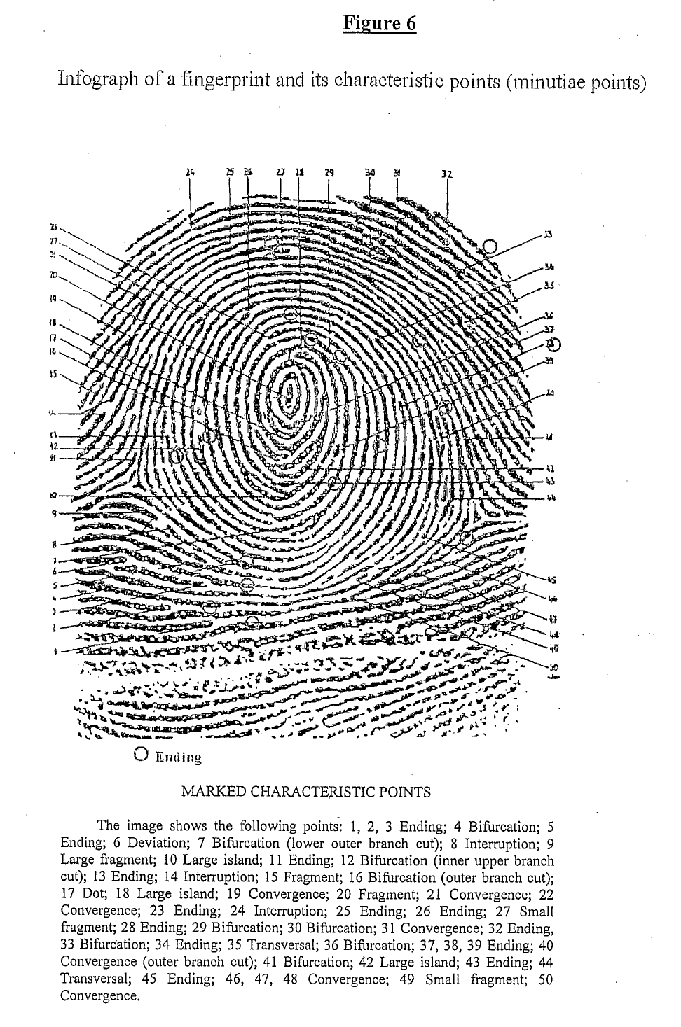

FIG. 6 shows the image of a digitalized fingerprint taken by a digital camera, optic scanner or any other imaging device.

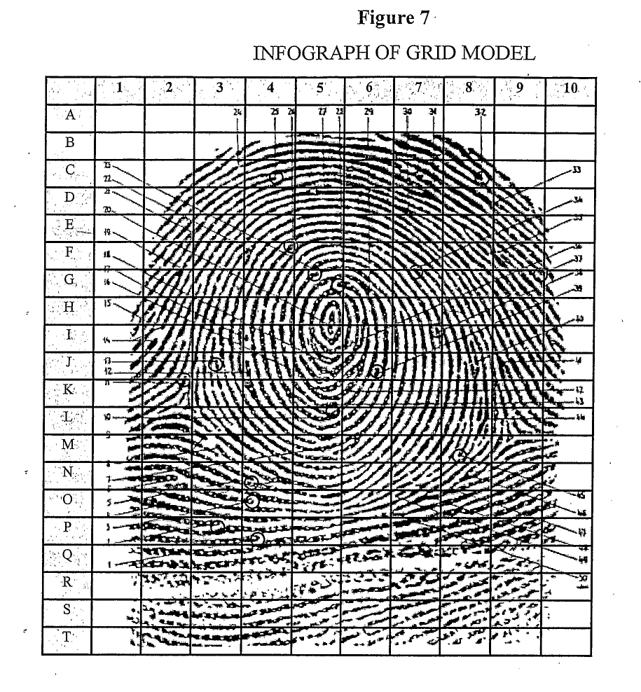

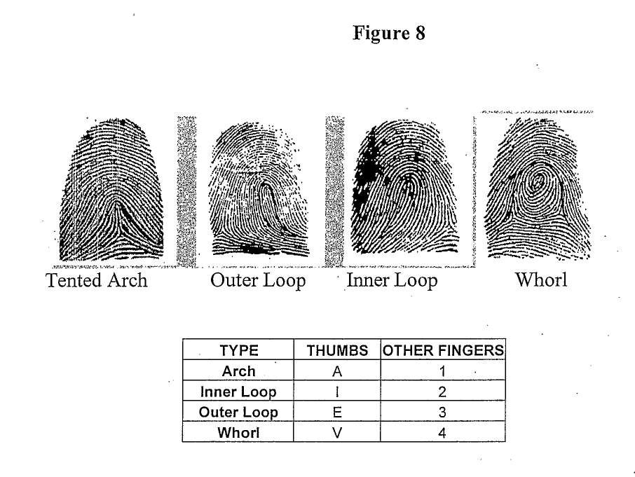

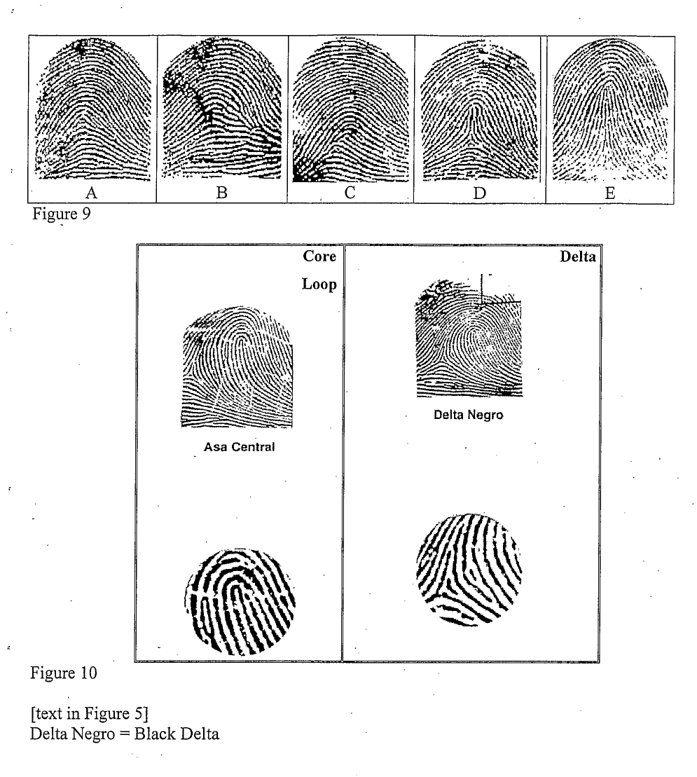

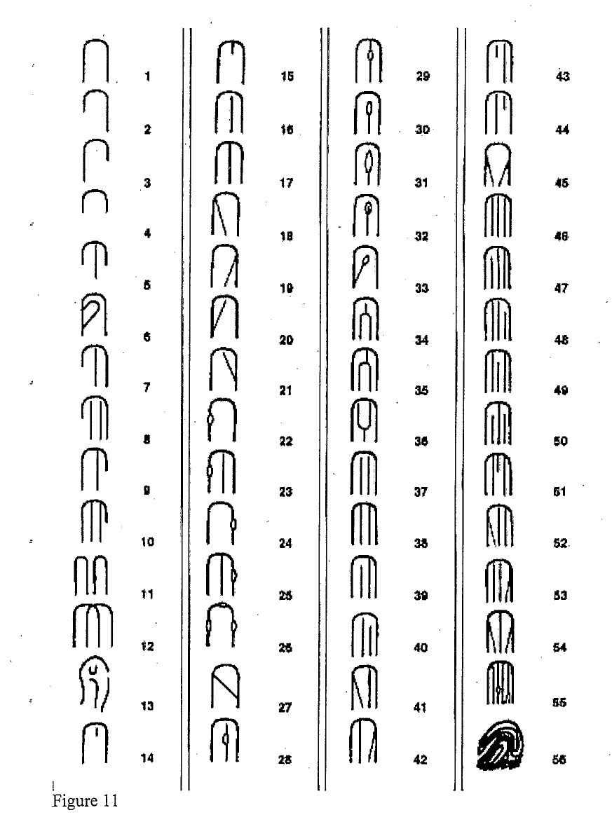

Once the image has been captured, the software of the proposed device clasifies it into one of four groups according to the Vucetich formula and then subclassifies it according to the fundamental group to which it belongs, see FIG. 8. Then it plots the print in question onto a grid-like chart, like the one shown in the representative model (see FIG. 7), where the minutiae points called the outlined characteristic points (FIG. 6) are determined and coded through the system's own techniques.

In this way we obtain an alphanumeric code from the fingerprint image that is transformed using the invention's conversion system, representing it in a one-dimensional or two-dimensional magnetic barcode.

Following is a description of the process on how to obtain a character chain from a fingerprint image (FIG. 9).

Once the image has been captured (step B, already described in phase 1) and plotted on a two-dimensional or three-dimensional grid (FIG. 2 shows the plotting of a two-dimensional image), it is coded by patterns (C). Once the image is in the memory as a result of having been digitalized (B), the software, in the event the image in memory corresponds to several fingerprints, performs a multiple segmentation, which means that it divides an image containing several fingerprints into several separate images, each containing one fingerprint. For example, if the data medium is a two-finger form, the software divides it into two separate print images; if it is a ten-finger card, it divides it into ten separate print images, etc. (see Images 1 and 2).

Once the images have been divided, work is done on each of them individually, starting with the first image obtained, by applying the processes that are going to be described further on until a character chain is obtained from the fingerprint, and the process continues in this manner until all the segmented images have been processed.

In the event the image in memory is of just one fingerprint, the multiple segmentation process is not applied and you proceed directly as indicated below.

Continuing with step (C), the next step for obtaining a code from each print is the individual segmentation process, eliminating the pixels that do not belong in the image of the fingerprint. With this, you get a smaller image than the original one and make it unnecessary to go over the image repeatedly, which lets the following operations that need to be done on the image be done faster and more accurately since you have eliminated information that does not belong to the print and that could introduce calculation errors (see Image 3).

Once the segmentation process has been completed, the software automatically performs a process to improve the image to eliminate noise, which is garbage that may have been introduced during the digitalization process or that comes from scanning the original image.

To do this, Fourier's two-dimensional transformation is applied to convert the data from the original representation into a frequency representation. Then a nonlinear function is applied so that the most useful information has more weight compared to the noise. Finally, the improved data are converted into a spatial representation.

The software then analyzes the quality of the image. This analysis will allow you obtain a quality index for the print and check whether the software should accept or reject the print depending on that index. This process analyzes the image and determines areas that are degraded and that are very likely to cause problems or lead to errors during subsequent analyses.

The quality analysis includes determining the directional flow of the ridges in an image and detecting regions of low contrast, low ridge flow and high curvature. These last three conditions represent areas in the image where the detection of minutiae points is unreliable and together can be used to represent quality levels in the image.

If the software determines that the image has enough quality it needs, it processes each image obtained from the segmentation in the manner shown in Image 4.

The software takes the image of the fingerprint in segmented memory in the form of a pixel vector whose number of elements is equal to the (width×height) of the image.

Then a search of the center part of the print is done using the following process because these areas have the highest curvature of ridges.

Two different measurements are used. The first one measures the cumulative change in the direction of the flow of ridges around all neighboring ones in a pixel block. The second measures the variation of change in direction between one flow of ridges in one pixel block and the flow of ridges in its neighboring blocks.

These two measurements provide the center point of the print and the delta(s) that will be used later on for classification and subclassification (see Image 5).

The image is binarized (passed from a gray scale to white and black) where the black pixels represent the ridges and the white ones the valleys.

To create this binarized image, all of the pixels in the image are analyzed to determine whether they should be assigned a white pixel or a black pixel. A pixel is assigned to a binary value based on the direction of the ridge associated with the block in which it is contained. If a flow of ridges is not detected in the block, the pixel is then converted to white. If a flow of ridges is detected, the intensity of the pixel surrounding the actual pixel is then analyzed using a 7×9 grid that is rotated until its rows are parallel to the direction of the flow of the ridge. The intensity of the pixel on a gray scale is accumulated throughout each row rotated on the grid, forming a vector of additional rows. The binary value assigned to the central pixel is determined by multiplying the total center row by the number of rows on the grid and comparing this value to the gray scale intensities accumulated on the overall grid. If the sum of the multiplied center row is less than the total intensity of the grid, then the center pixel is converted to black; otherwise, the pixel is converted to white (see Image 6).

The step following binarization is the calculation of the local orientation of ridges and valleys. To do this, the orientation of ridges and valleys of the image is calculated by dividing the image of the print (Image 7) into non-overlapping blocks of size W×W. The software calculates gradients Gx (i, j) and Gy (i, j) of each pixel (i, j) using the Sobel or Marr-Hildreth operator.

The local orientation of the ridge varies slightly in neighboring blocks where nonsingular points appear (points that are not corer or delta parts of the print).

The software applies a low-pass filter to modify the local orientation of the ridge. To apply it, the orientation image is converted into a field of continuous vectors. Then a 2-D low-pass filter size W×W is applied in blocks of 5×5 pixels. From this, the local orientation of each point (i, j) is calculated.

Then the general orientation of the print is calculated depending on the field of orientation obtained in the step above (Image 8).

After that, the grid is configured onto the vector of the image in question, taking preset row and column height and width values (according to the application). Depending on the data obtained by way of the above mentioned algorithms, the center point of the grid is inserted into the center of the image, and its orientation is known by the general orientation obtained from the print in the above step. This step introduces novel aspects compared to current techniques, because while known methods scan minutiae points without relating them with the orientation of the print, which forces you to perform an infinite number of combinations afterwards in order to verify matches of relative distances between them, the proposed method only performs one comparison per minutiae, since all of them come from prints that have been oriented in advance (Image 9).

Then, the software labels the grid with letters and numbers, meaning that it labels the rows with letters and the columns with numbers, or it assigns each square on the grid a number, starting from the center and working outward to the edges clockwise. This allows the number of characters in the resulting chain to be reduced by using just one character per square, and not two like traditional methods use.

After that, the image resulting from inserting the grid onto the fingerprint is displayed on the screen, and this concludes step (C).

Step (D): this step is the one that defines the novelty of the proposed process, and so it is the one that lets you obtain the desired results in terms of accuracy and speed that distinguish this proposed process from other known techniques. It involves a fingerprint classification and subclassification step, depending on the characteristics present on the drawing of the ridges, which prevents you from having to search groups of prints later that have characteristics that are not similar to the ones we want to find. This is the key to obtaining fast and effective results, compared to the traditional methods which, since they do not classify characteristics, require you to search for a print by comparing it with all existing ones.

The software displays on the screen the indications to recognize and identify the four fundamental Vucetich groups, plus exceptions, and the coding system according to the fingers (thumb or other fingers). The exceptions mentioned above come about in cases where the print displays anomalies (scars, injuries, etc.) that prevent it from falling normally into one of the four fundamental groups.

The indications cited above that the software displays on the screen are the location of the center of the print and the location of the delta(s) of the print, if any.

The operator selects the fundamental group to which the fingerprint entered in terms of the above indications belongs, on the basis of which the first character for coding the fundamental group is going to be obtained.

Step (E): The system displays on screen, depending on the fundamental group selected in the above step, the possible subclassifications for this fundamental group. These depend on the type of print you are analyzing, meaning whether it is a rounded, flat or latent print taken using technology stemming from U.S. Pat. No. 6,659,038, using printed ink or live prints using a print sensor.

Subclassification is done according to the following information, keeping in mind that the characters between comas are the subclassification codes the software will take in order to add them to the resulting coding chain.

If the classification selected in the step above is “arch”, for both rolled or flat prints, the possible subclassifications are (see FIG. 9):

“A”: Flat or plain arch: when the papillary ridges run from one side to the other of the print, almost parallel to one another, forming distended arches.

“B”: Left-leaning arch: when one or more independent ridges making up the center of the print have a certain lean toward the left.

“C”: Right-leaning arch: when one or more independent ridges making up the center of the print have a certain lean toward the right.

“D”: Small or low tented arch: when the ridges making up the center of the print go upward toward the upper margin to a relatively low height.

“E”: Big or high tented arch: when the ridges making up the center of the print go up to the top to a relatively significant height.

If the classification selected in the step above is “loop”, both outer and inner, you should keep in mind that there two essential elements to subclassify them: the delta formation (delta) and the core loop (see FIG. 10), considering that for the subclassification exclusively the “core loop” should be taken into account and all the “accidents” that may be present inside it.

“Core loop” should be understood as the core-most papillary ridge, the one that forms a peak curve and doubles back, keeping a certain degree of parallel with the previous one, and goes back toward the same area of the base of the print it started in.

In addition, “delta” should be understood as the more or less regular triangular form that is formed as a result of the confluence of ridges. The delta is made up of three ridges called the ascending line, the descending or directional line, and the appendix or tail.

Consequently, the possible subclassifications when the print being analyzed is plain are (see FIG. 11):

“1”: Clean core loop

“2”: Clean core loop, left branch truncated

“3”: Clean core loop, right branch truncated

“4”: Clean core loop, both branches truncated

“5”: Clean core loop, both branches truncated, with one or more axial lines (either attached or not attached to the top).

“6”: Core loop whose two branches are attached to the same branch of the closest loop (right or left)

“7”: Core loop, left branch truncated, with an axial line (either attached or not attached to the top)

“8”: Core loop, left branch truncated, with two or more lines either attached or not attached to the top)

“9”: Core loop, right branch truncated, with two or more axial lines (either attached or not attached to the top)

“10”: Core loop, right branch truncated, with two or more axial lines (either attached or not attached to the top)

“11”: Double core loop (with or without axial lines)

“12”: Intertwined core loops (with or without axial lines)

“13”: Irregular core loop

“14”: Core loop, with small island or cut not attached to the top

“15”: Core loop, with small island or cut attached to the top

“16”: Core loop with an axial line not attached to the top

“17”: Core loop with an axial line attached to the top

“18”: Core loop with an axial line attached to the top of the left branch

“19”: Core loop with an axial line attached to the top of the right branch

“20”: Core loop with an axial line attached to the bottom of the left branch

“21”: Core loop with an axial line attached to the bottom of the right branch

“22”: Clean core loop forming an enclosure on the left branch

“23”: Core loop forming an enclosure on the left branch, with one or more axial lines (either attached or not attached to the top)

“24”: Clean core loop forming an enclosure on the right branch

“25”: Core loop forming an enclosure on the right branch, with one or more axial lines (either attached or not attached to the top)

“26”: Core loop forming an enclosure on both branches or at the top (with or without axial lines)

“27”: Core loop with an axial line connecting the branches

“28”: Core loop with an axial line that has a clean enclosure (small, medium-size or large), either with or without prolongation, not attached to the top (either with or without up to two other lines)

“29”: Core loop with an axial line that forms a clean enclosure (small, medium or large), with prolongation, attached to the top (either with or without up to two other lines)

“30”: Core loop with an axial line forming a clean enclosure (small or medium), without prolongation, either attached or not attached to the top, with or without up to two other lines

“31”: Core loop with an axial line forming a clean enclosure, large, without prolongation (either attached or not attached to the top, either with or without up to two other lines)

“32”: Core loop with an axial line forming a penetrated enclosure (small, medium or large), with or without prolongation, either attached or not attached to the top, either with or without up to two other lines

“33”: Core loop with an axial line forming a clean or penetrated enclosure (small, medium or large), attached to either of the lower branches (either with or without up to two other lines)

“34”: Core loop with a downward fork or bifurcation not attached to the top (either with or without up to two other axial lines).

“35”: Core loop with a downward fork or bifurcation attached to the top (either with or without up to two other axial lines).

“36”: Core loop with an upward fork or bifurcation either attached or not attached to the top, either with or without up to two other axial lines.

“37”: Core loop with two axial lines not attached to the top.

“38”: Core loop with two axial lines attached to the top.

“39”: Core loop with two axial lines, the left one stunted, the right one either attached or not attached to the top.

“40”: Core loop with two axial lines, the right one stunted, the left one either attached or not attached to the top.

“41”: Core loop with two axial lines, the left one attached to either end of the branch, the right one either attached or not attached to the top.

“42”: Core loop with two axial lines, the right one attached to either end of the branch, the left one either attached or not attached to the top.

“43”: Core loop with two axial lines, the left one a small island or cut (either attached or not attached to the top, the same as the right one).

“44”: Core loop with two axial lines, the right one a small island or cut (either attached or not attached to the top, the same as the left one).

“45”: Core loop with two axial lines, both attached to either end of their branches.

“46”: Core loop with three axial lines reaching the top (either attached or not attached).

“47”: Core loop with three axial lines, the left one stunted and not attached to the branch, the other two either attached or not attached to the top.

“48”: Core loop with three axial lines, the right one stunted and not attached to the branch, the other two either attached or not attached to the top.

“49”: Core loop with three axial lines, the center line stunted, the other two either attached or not attached to the top.

“50”: Core loop with three axial lines, the lateral lines stunted and not attached to the branches, the center line either attached or not attached to the top.

“51”: Core loop with three axial lines, the center line or lateral lines are a small island or cut, and the two either attached or not attached to the top.

“52”: Core loop with three axial lines, the left attached to either end of the branch, the other two either attached or not attached to the top.

“53”: Core loop with three axial lines, the right one attached to either end of the branch, the other two either attached or not attached to the top.

“54”: Core loop with three axial lines, the lateral lines attached to either end of their branches, the center line either attached or not attached to the top.

“55”: Core loop with four or more axial lines or having a diversity of drawings that either reach or do not reach the top, either attached or not attached.

“56”: Double loop or intertwined loop.

“Axial lines” are understood as two ridges (independent lines) that join, touch or come together at the upper edge and are located inside of the core loop.

For rolled prints, they can be subclassified according to the number of ridges between the delta and the core.

Consequently, the type of subclassification would be:

“A”: from 2 to 4 ridges

“B”: from 5 to 8 ridges

“C”: from 9 to 12 ridges

“D”: from 13 to 15 ridges

“E”: from 16 to 18 ridges

“F”: from 19 to 21 ridges

“G”: from 22 to 24 ridges

“H”: from 25 to 27 ridges

“I”: 28 ridges and above

If the classification selected in the previous step is “whorls”, a careful analysis should be done of its core configuration, because depending on the evolution adopted by the ridges in that area, it will be the key to apply.

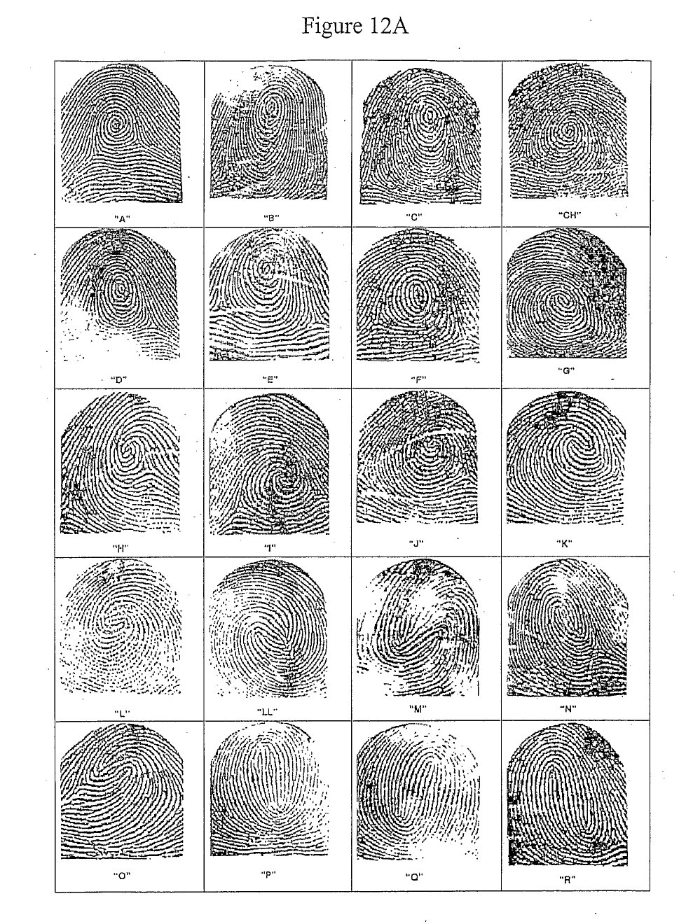

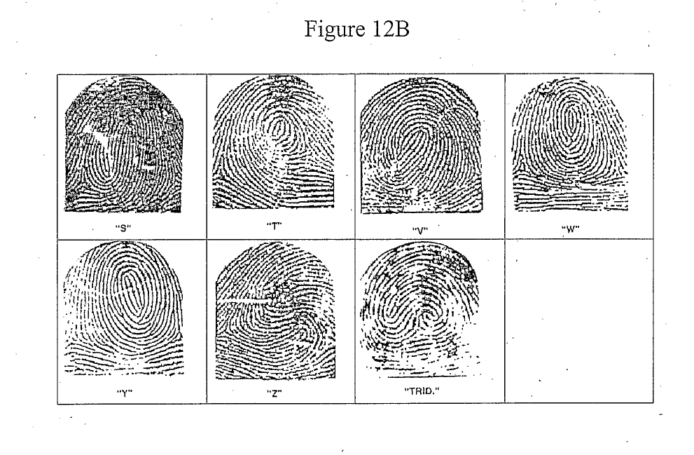

This analysis is just for plain prints, so the possible subclassifications are (see FIGS. 12A and 12B):

“A”: Leftward spiral

“B”: Rightward spiral

“C”: Open circumference

“CH”: Circumference

“D”: Penetrated circumference

“E”: Open circumference

“F”: Elongated spiral

“G”: Simple right core curvature

“H”: Simple left core curvature

“I”: Simple right hooked curvature

“J”: Simple left hooked curvature

“K”: Compound right core curvature

“L”: Compound left core curvature

“LL”: Compound right hooked curvature

“M”: Compound left hooked curvature

“N”: Right angular core curvature

“O”: Left angular core curvature

“P”: Right elongated core curvature

“Q”: Left elongated core curvature

“R”: Right angular elongated curvature

“S”: Left angular elongated curvature

“T”: Normal perfect oval

“V”: Large perfect oval

“W”: Penetrated oval

“Y”: Open oval

“Z”: Independent curvature

“TRID”: Tridelta

Other Whorl subclassifications for rolled prints are:

By directional lines:

“S”: the descending line of the left delta crosses the descending line of the right delta, with one or more ridges between them.

“D”: the descending line of the left delta passes underneath the descending line of the right delta, with one or more ridges between them.

“M”: both descending lines join at the base of the fingerprint or they do so when the path is long.

To count lines: this is done from the left delta to the core or nucleus of the whorl, by the Galton line.

Galton line is understood as the imaginary straight line running from the delta to the center of the print.

Rules for counting ridges for the nucleus:

“a”: when a spiral is found in the nucleus: the Galton line will be supported on the initial ridge of the spiral, regardless of whether it is a leftward or rightward spiral.

“b”: when there are circumferences or clean, open or closed ovals in the nucleus: the Galton line will be supported in the upper cusp of the circle or oval.

“c”: when penetrated open or closed circumferences are present in the nucleus: the Galton line will be supported on the tip or head of the small island or on the same point of penetration.

“d”: when there is simple curvature in the core: the concept for case “a” is applied.

“e”: when there is simple or compound, hooked, same characteristics, short or elongated curvature in the nucleus in a vertical or elongated position: the Galton line will always be supported at the beginning of the curvature, in the cusp or curve of the loop closest to the left delta, or at the top of the center axial line this same loop may have.

Out of the print subclassifications proposed here, you could choose any method or combination, depending on the case to be subclassified.

The operator indicates the subclassification the fingerprint in question pertains to, and then the software obtains the second character for the print subclassification code.

Step (F): The software scans the grids outward from the center toward the edges clockwise.

Step (G): If any minutiae points are detected in the square being analyzed, coding begins by scanning the square from the upper left corner to the lower right corner.

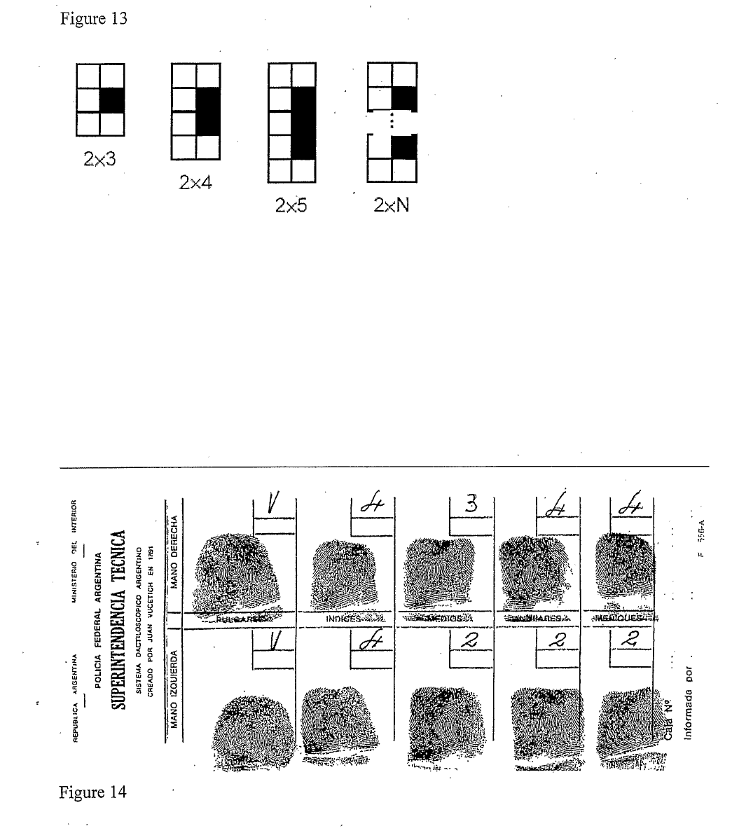

Minutiae detection is done as follows: the software goes over the binarized image of the fingerprint and identifies the pixels that respond to standard minutiae patterns that indicate end of a ridge or a bifurcation. The patterns contain six binarized pixels in a 2×3 configuration (2 columns×3 rows) for ridge ends. This pattern can represent the end of a ridge projecting to the right. It is also valid for a 2×4 pixel pattern. The only difference between this pattern and the first one is that the pair of pixels in the middle is repeated. This group of ridge end patterns can be represented as described above, where the middle pair is repeated “n” number of times (see FIG. 13).

Ridge end candidates are detected on the image by consecutively scanning pixel pairs in the image sequentially, comparing these patterns. Scanning is done both vertically and horizontally.

Using these patterns, a series of candidate minutiae points is detected.

It is also detected whether the minutiae starts or ends (appears or disappears).

This determines the direction or placement of the minutiae.

To detect bifurcations, other patterns and a similar process to the one described for ridge ends are used.

The software detects and eliminates false minutiae points, ones that are included on the list of candidate minutiae points obtained in the preceding step.

Eliminating false minutiae points includes what are called islands, lakes, dots, minutiae points in low quality regions, hooks, overlaps, pores, etc.

Each minutia is codified considering:
Grid where it is located
Type of minutiae
Quality
Orientation or Direction

Step (H): The values mentioned in the preceding breakdown are four alphanumeric values. As the minutiae points are obtained, their coding is added to the final resulting chain that represents the fingerprint.

Step (I): This involves the final makeup of the resulting chain you want to obtain. The classification code union obtained in step (D) of FIG. 4 (first character)+the subclassification code obtained in step (E) FIG. 4 (second character)+the minutia coding chain obtained in step (H) FIG. 4 generates a series of characters of variable length, unique to every fingerprint, which is called the “alphanumeric chain”, and it constitutes the resulting letter and numerical representation of the processed fingerprint.

It is possible to add any other relevant additional information seen in the fingerprint image. This will give you more information about the fingerprint and will be added to the final alphanumeric chain as complementary information and is of great important when two chains corresponding to fingerprints are compared or to reduce the number of subgroups to be searched.

This will give the system a faster response time.

All of this depends on the quality with which the fingerprint was captured.

The code can also be the fingerprint identification of a ten-finger print form, a two-finger print form, summarized number, background, document, file, etc.

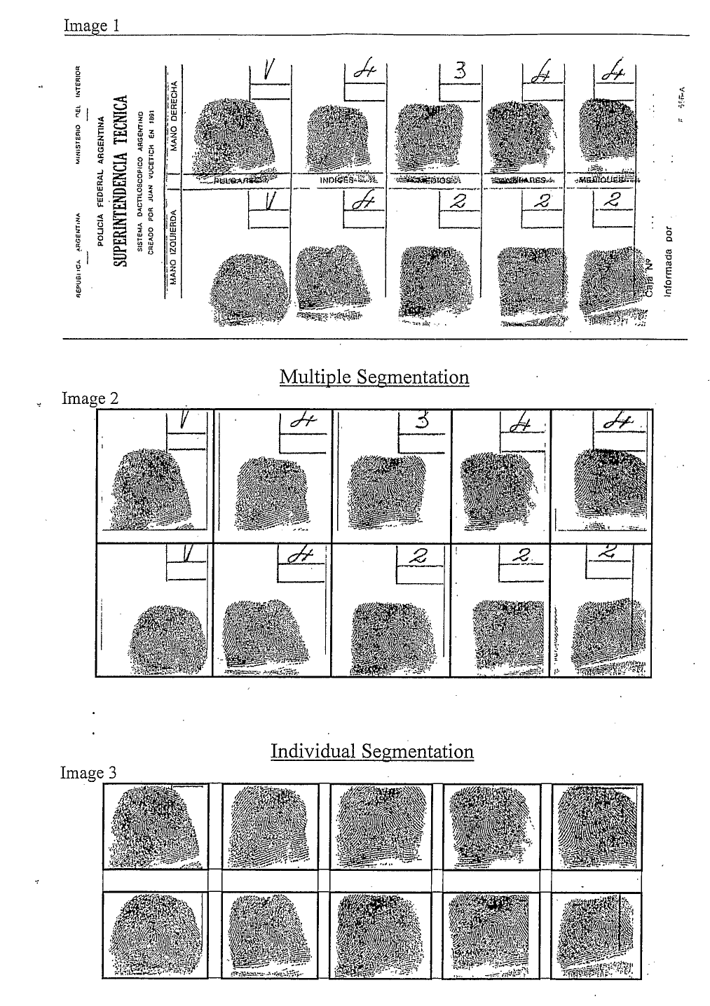

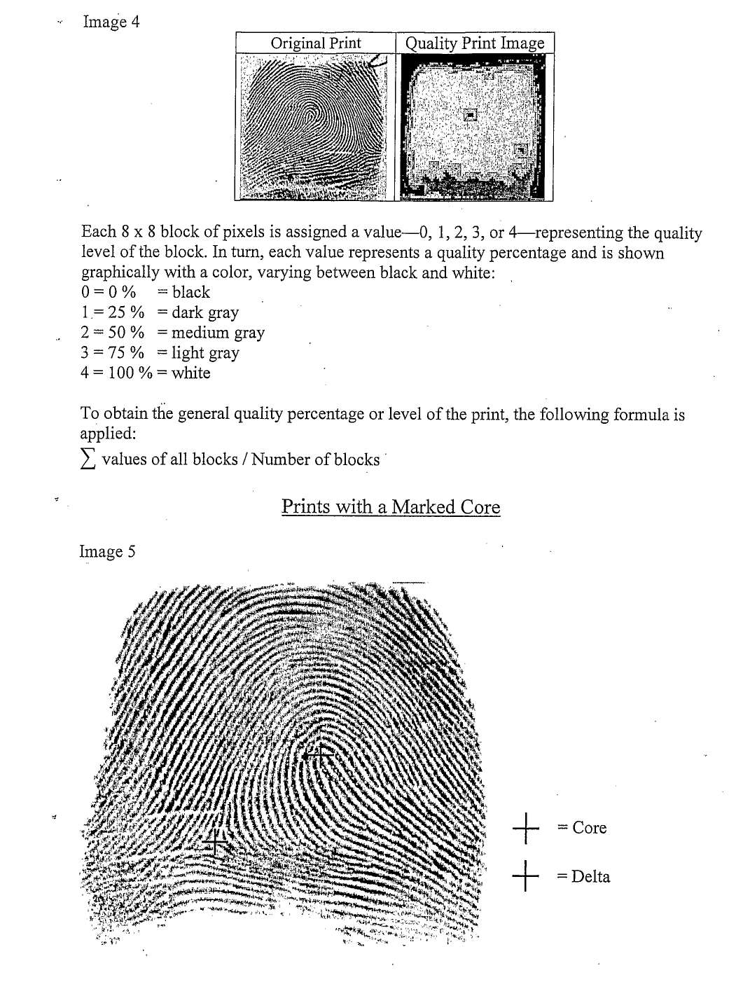

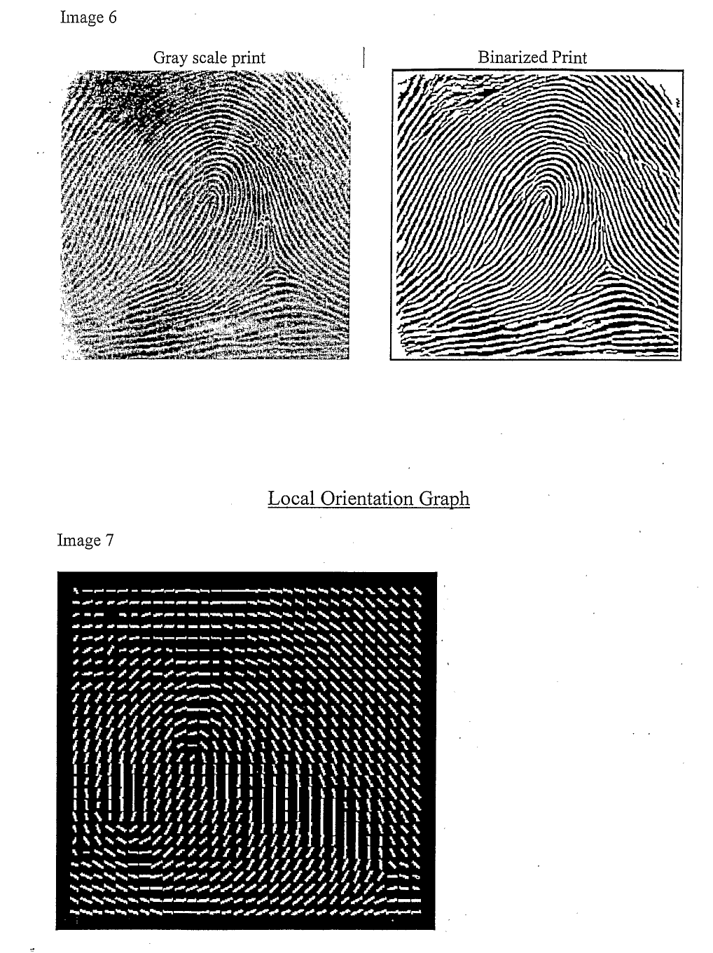

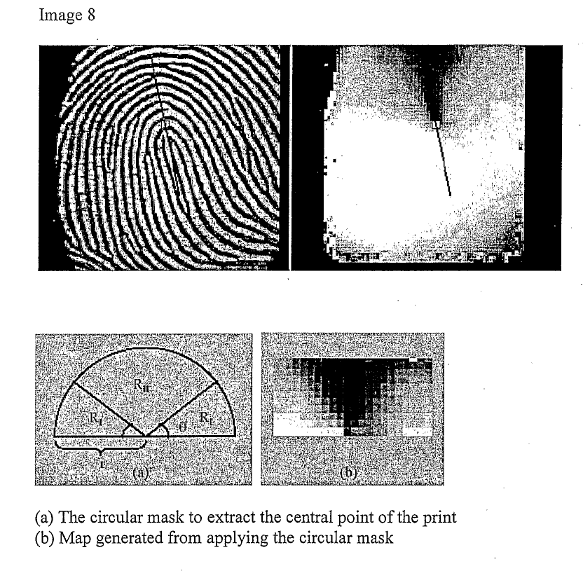

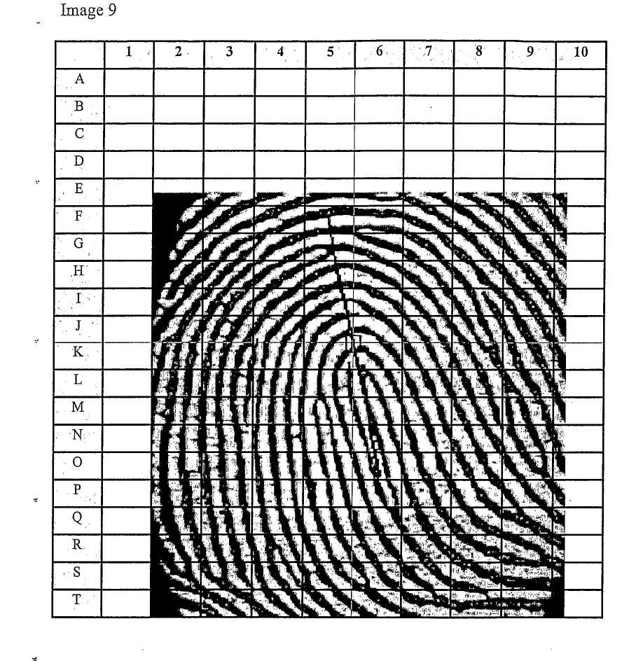

An example of Fingerprint Identification can be seen in FIG. 14.

The last two steps of the process to obtain a character chain from the image of a fingerprint (FIG. 4) are steps (J) and (K), which coincide with the steps in phase 1 having the same name.

Nonetheless, they are included again below.

In step (J) a barcode character coding program is used to represent the character chain(s) obtained. You can represent both a fingerprint as well as any other information that can individualize a person, depending on the case it is applied to, such as:
Identity Credential Number
Name
Fingerprint Identification
Any combination of the above

Depending on the number of characters to be represented, a one-dimensional barcode or a two-dimensional code will be used.

In the next step (K), the software sends the barcode information to be printed by a thermal or laser printer or a printer of similar technology that gives the printed barcode enough quality needed to be read by the laser reader.

The physical support on which the barcode can be printed can be any of the following: self-adhesive label or sticker that can be removed and affixed to any document, or the aforementioned X-form, Identity document, Passport, or any other personal identification medium that shows the printed barcode.

This way, the resulting database will remain segmented in four principal print groups and subgroups generated from the subclassification, with other optional subgroups added (for example, male and female), making subsequent searches easier because it will only be done in the subgroup corresponding to the classification, reducing the amount of time and resources spent on searches you know will be negative beforehand, meaning that in this step the discard method is used.

Once the corresponding search subgroup in the database has been located, you proceed to verify the person by comparing the rest of the alphanumeric chain generated by the algorhythm by way of the characteristic points taken from the fingerprint plotted on the grid developed by the invention's procedure.

The possibility of doing a partial search, from one incomplete print or partial print, brings in another novelty of this system compared to identification systems currently in existence.

Since the proposed procedure is based on classifying and subclassifying the type of print obtained beforehand, the software can be designed to locate a specific complete fingerprint from a partial print. This is so because the system limits the search field to the partial print entered (for example, for a criminal act where only a partial print was lifted), and so the software will compare it against another one until it finds a match to the partial print that was obtained. After that, using the system's own grid system described above, it will reconstruct the print by adding its missing parts, according to information found in its database where the full print that was registered when the data of the suspect were input will emerge.

This is another one of the big advantages that are obvious when comparing the proposed invention to systems currently being used, since none of the known ones is able to reconstruct a print completely by entering a partial print into the system.

The systems that are still being used in highly developed countries compare the common points of that partial print to all prints stored in the database. The number of matches between those partial prints might have five digits, which makes it very hard or virtually impossible to identify a person from a partial print out of a group of 50,000 people, for example. Currently, you have to resort to powerful computer systems to be able to compare prints found or taken from a person with the ones found in government databases. In spite of this, these systems turn out to be inefficient, because they tend to “go down” or “freeze” when the number of prints exceeds five digits and if you can find the print you are looking for, the delay in getting the desired result is more than considerable. As for problems with the system going down and a delay in getting a result, it should be added that the known computer systems are comparing images that in many cases are defective and are rejected by the system because it cannot read them properly.

The proposed procedure is faster and more efficient because it does not compare all of the prints in the database, but only the ones belonging to the same principal group and its subclassification, and it accepts old, defective or poorly taken prints (with ink stains or smudges) and equips them with recently taken new prints.

This demonstrates the advance applying this invention would have in the technical field, because up to now the problems stated above have not been addressed successfully using known devices.

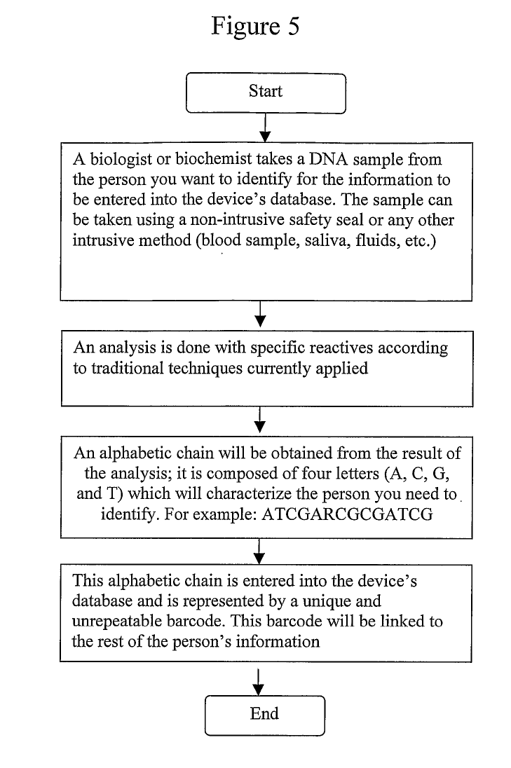

Lastly, we should describe the process of converting a genetic code into a barcode (FIG. 5).

As stated above, the proposed procedure can, through a device it uses, convert a genetic code obtained from a person's DNA analysis into a barcode to be incorporated into his personal documentation.

To explain this process, we first need to offer a summary about how a Genetic Chain is constructed from a DNA analysis.

Several factors intervene in this process. Some of them are: Cell: minimum unit the human body is made up of.

Molecule: the smallest particle of a substance that stores and maintains the chemical and specific properties of that substance, when we refer to DNA.

Protein: large molecule made up of one or more chains of amino acids in a specific order.

Nucleus: cellular organ that contains the genetic material.

DNA—Deoxyribo Nucleic Acid: the molecule that codifies genetic information and that contains four nucleotides: (A) Adenine, (G) Guanine, (C) Cytosine, and (T) Thymine.

Genetic Code: process whereby the codified information of a gene is converted into structures present in a cell through the different positions of the nucleotides.

Example of a genetic code sequence: ATCGATCGCGATCG. This is the language of the human genome.

Below we are going to describe how, once a genetic code is obtained, the process to turn it into a barcode representation takes place.

The instructions of a genetic code are written on the DNA in the form of a ladder. Each rung is made up of a pair of chemical substances that only bind between one another.

If half of a rung is composed of (A) Adenine, the other is always (T) Thymine, and if one half is (G) Guanine, the other half is (C) Cytosine.

Biochemists and biologists tend to refer to the four basic DNA molecules by their initials: A, T, G, and C.

So we have, in conclusion, that DNA is a long succession of four chemical components whose initials are A, G, C, and T, and the written formula of a person's DNA is an alphabetic code like: ATCGATCGCGATCG.

In this manner, when a character chain representing a person's genetic code is entered into the system, the software will automatically convert it into barcodes using the technology described in step (Q) phase 1.

In summary, the invention's procedure successfully addresses the problems that have yet to be solved and that need to be solved using modern techniques, problems such as the aforementioned safety, speed (search in subgroups and not in the whole database), anti-fraud (does not allow the same print to be entered more than once with different names), enabling the complete reconstruction of a print from a partial print (current systems do not admit this possibility) and incorporating barcode technology applied to fingerprints and genetic codes.

It is evident that several operating modifications can be introduced in the procedure we are describing, as well as to the design and configuration of the device, without moving away from the scope of this invention patent, which is clearly determined due to the scope of the following claims.

1) Person identification system characterized by converting fingerprints and genetic codes into barcodes, including these steps:
obtaining a fingerprint by a digital device;
plotting the digital image of a print onto a predetermined alphanumeric two-dimensional grid or stencil in segments with the measurements identified by letters and/or numbers;
classifying the print into one of the possible existing groups;
subclassifying the print according to the classification to which it belongs;
determining the characteristic points of the fingerprint and coding in the alphanumeric information; and
converting the alphanumeric code obtained into barcodes using conventional methods.

2) The person identification procedure according to claim 1, wherein if a person needs to be identified by his DNA, including the following steps:
obtaining the genetic code of a person by any intrusive or non-intrusive method; and
converting the code obtained (alphabetic character chain) into barcodes using conventional methods.

3) The person identification procedure according to claim 1, including the step of linking the barcode obtained to the rest of the person's information.

4) The person identification procedure according to claim 1, wherein the alphanumeric grid is three-dimensional.

5) The person identification procedure according to claim 1, wherein the step for determining the characteristic points of the fingerprint and coding them into alphanumeric information is done taking into consideration the specific square of the grid the characteristic point is found.

6) The person identification procedure according to claim 1, wherein the procedure includes steps prior to inputting the information into the database consisting of the following steps:
completing a form with the personal data and a fingerprint of the person using an organic safety seal that removes the remains of cells attached to the adhesive material of that organic seal;
inputting data from the form into the database and having the system check to make sure that the data has not already been entered, if entered, the software will prevent it from being inputed;
capturing the fingerprint using a digital device and inputing into the database, checking to make sure it has not already been inputed, if entered, the software will check to make sure that the print is linked to the data registered on the form, and if they do not match, it will not allow that print to be inputed into the system;
inputting the genetic code of the person if the DNA analysis has already been done, checking to make sure it has not already been inputed, if entered, the software will check that the genetic code is linked to the data found on the form, and if they do not match, the software will not let that genetic code be inputed;
assuming both the alphanumeric and alphabetic character chains corresponding to the genetic code have not been inputed, they are converted into a barcode; and
printing this barcode that has been obtained on the necessary identity documents.

7) The person identification procedure according to claims 1, wherein this procedure permits checking a person's identity through the following steps:
providing the form with an organic safety seal;
providing a personal identification method with a printed barcode;
reading the barcode printed on the means of identification using a barcode reader;
using the software to bring up on screen all of the information corresponding to the barcode read by the reader;
obtaining the fingerprint of the person using a digital medium;
using the software to generate an alphanumeric character chain and comparing it to the chain corresponding to the print that was previously stored in the database;
wherein if both alphanumeric character chains match, it ends the verification procedure by verifying that it is the same person, otherwise the software will generate a notice reporting that the chains do not match and it is not the same person.

8) The person identification procedure according to claim 1, wherein this procedure lets a person be identified by a fingerprint and involves the following steps:
obtaining a person's fingerprint using a digital medium;
using the software to classify and generate a chain of alphanumeric characters and check whether the chain already exists by comparing it to the chains of that same subgroup that were previously stored in the database;
wherein if the software finds that the chain corresponding to the inputted print, the identification process ends and it is corroborated that it is the same person and the computer brings up on screen the information entered that the operator is requesting, otherwise the software generates a notice informing that the chain of alphanumeric characters obtained is not entered in the database showing that it involves an undocumented person.

9) The person identification procedure according to claim 2, wherein the procedure enables people to be identified by their DNA, and it consists of the following steps:
performing a DNA analysis on the person to be identified using any intrusive or non-intrusive method;
once the genetic code is obtained entering it into the computer system;
using the software to search the database for the alphabetical character chain corresponding to that genetic code and checking to see whether it is already in the system by comparing it to the alphabetic chains previously stored in the database;
wherein if the software finds the chain corresponding to the genetic code entered, the identification process ends, and it is corroborated that it is the same person and information is brought up on screen requested about this person, otherwise the software generates a notice reporting that the alphabetic character chain of the genetic code is not in the database, which shows that it involves an undocumented person.

10) The person identification procedure, according to claim 6, wherein the fingerprint that is captured digitally is not taken as a whole, but rather is plotted on a two-dimensional grid, and one alphanumeric chain is obtained for each square.

11) The person identification procedure according to claim 6, wherein the three-dimensional method is used to code the full fingerprint from a partial print.

12) The person identification procedure according to claim 1, wherein the two-dimensional grid is variable in the width and height of its rows and columns.

13) The person identification procedure according to claim 6, wherein the search the software performs is based only on certain characteristic points of the alphanumeric code.

14) The person identification procedure according to claim 6, wherein the search the software does is by scanning only certain squares searching out matching points.

15) The person identification procedure, according to claim 6, wherein the search the software performs is done by combining just certain characteristic points of the alphanumeric chain in specific squares.

16) The person identification procedure according to claim 13, wherein from a partial print the software reconstructs the entire print found in matches of specific characteristic points.

17) The person identification procedure according to claim 1, wherein prior to the classification and subclassification steps, steps involving segmenting the image obtained, dividing the image containing several fingerprints into several separate images each containing a fingerprint are added, and each of them is worked individually according to the following steps:
segmenting each image eliminating the pixels that do not pertain to the print;
improving the image by eliminating noise;
performing a quality analysis of the print, and an determined quality index is obtained, if it is the right one, the image is processed as follows:
searching on the core of the print;
binarizing the image where black pixels represent ridges and white ones the valleys;
calculating the local placement of ridges and valleys;
calculating the general orientation of the print;
configuring the grid and its central point is inserted in the center of the image;
numbering and lettering the grid and each square is assigned a character graphically displaying the image resulting from inserting the grid onto the fingerprint.

18) The device used in the procedure of claim 1, including a series of devices or apparatus that are interrelated, a digital medium to capture images, a computer containing the information system, a database, a barcode laser reader, and a printer.

19) The device according to claim 18, wherein the database engine can be in a server.
